(19) United States
(12) Patent Application Publication
(10) Pub. No.: US 2014/0041466 A1
(43) Pub. Date: Feb. 13, 2014

(54) RACK-PINION TYPE STEERING APPARATUS

(71) Applicant: MANDO CORPORATION, Pyeongtaek-si (KR)

(72) Inventors: Myung Seob SON, Seoul (KR); Jong Seo WOO, Daegu (KR); Boo Ki LEE, Wonju-si (KR); Je Hyeon YEON, Wonju-si (KR)

(73) Assignee: MANDO CORPORATION, Pyeongtaek-si (KR)

(21) Appl. No.: 13/964,761

(22) Filed: Aug. 12, 2013

(30) Foreign Application Priority Data
Aug. 13, 2012 (KR) 10-2012-0088240

(51) Int. Cl. B62D 3/12

(52) U.S. Cl. CPC B62D 3/12
USPC 74/30

(57) ABSTRACT

Disclosed is a rack-pinion type steering apparatus. According to the present invention, since air can flow into the interior of a gearbox from the exterior of the gearbox, unlike in the conventional structure in which an internal air flow into the gearbox is blocked at a portion of a rack-pinion type steering apparatus connected with the gearbox through a rack housing and a bellows, a problem of increasing internal pressure of the bellows in a predetermined case can be solved, and accordingly, generation of noise due to the collision between an inner peripheral surface of the bellows and an inner ball joint can be prevented.

### CROSS-REFERENCE TO RELATED APPLICATION

This application claims priority from and the benefit under 35 U.S.C. §119(a) of Korean Patent Application No. 10-2012-0088240, filed on Aug. 13 2012, which is hereby incorporated by reference for all purposes as if fully set forth herein.

### BACKGROUND OF THE INVENTION

1. Field of the Invention

The present invention relates to a rack-pinion type steering apparatus, and more particularly to a rack-pinion type steering apparatus which allows an interior of a gearbox to communicate with exterior air to solve the problem of increasing internal pressure in a bellows in a predetermined case, and accordingly, prevents noise from being generated due to collision of an inner peripheral surface of the bellows and an inner ball joint.

2. Description of the Prior Art

FIG. 1 is a schematic diagram of a rack-pinion type steering apparatus according to the related art. FIG. 2 is a sectional view of a main part of a gearbox of FIG. 1.

As shown in the drawings, the rack-pinion type steering apparatus according to the related art includes: a steering wheel 100 disposed in the driver's seat, a steering shaft 105 connected to the steering wheel 100; a steering column 103 for fixing the steering shaft 105 to a vehicle body; a gearbox 130 for converting a rotating force input from the steering shaft 105 into a linear movement of a rack bar 140 having a rack gear 110 on an outer peripheral side thereof and having inner ball joints 135 at opposite ends thereof; a pair of tie rods 150, one side of which is coupled to the inner ball joint 135 and an opposite side of which is coupled to a knuckle 159 connected to a tire 158 through an outer ball joint 155; a rack housing 170 coupled to the gearbox 130 and in which the rack bar 140 is located; and a pair of bellows 180 coupled to opposite ends of the rack housing 170 and the tie rods 150.

Meanwhile, the gearbox 130 includes: a housing 210; a hollow input shaft 220 for receiving a rotation from the steering shaft 105; a pinion shaft 222 integrally formed with a lower portion of the input shaft 220 and having a pinion gear 120 on an outer peripheral surface thereof; a rack bar 140 having a rack gear 110 engaged with the pinion gear 120, for converting a rotation input from the steering shaft 105 into a linear movement; a bearing 230 installed within the housing 210 and surrounding an outer peripheral surface of the input shaft 220 to support the input shaft 220; a stop ring 240, an upper side of which is positioned on an outer peripheral surface of the input shaft 220 and an opposite side of which is positioned on an upper surface of the bearing 230 to be press-fitted for supporting the bearing 230; a plug coupled to an upper inner peripheral of the housing 210, installed at an upper portion of the bearing 230, and through which the input shaft 220 passes; a dust seal 260 provided on an upper inner peripheral surface of the plug 250 to surround an outer peripheral surface of the input shaft 220; an O-ring installed between the plug 250 and the housing 210 to prevent the leakage of oil; and a dust cap 280 coupled to an upper portion of the housing 210 to prevent foreign substances such as dust or water from penetrating into the housing 210 from the outside.

However, since air flow with the outside is basically blocked in an interior of the gearbox at a portion of the rack-pinion type steering apparatus connected to the gearbox through the rack housing and the bellows, an internal pressure of the gearbox instantaneously increases as the rack bar is abruptly linearly moved and the bellows is abruptly contracted when a driver abruptly manipulates the steering wheel. Further, when air in the bellows is expanded and a pressure of the bellows increases due to the use of an air conditioner, ground heat, and the like, the increased internal pressure causes abnormal deformation of a shape of the bellows when the vehicle is steered, causing noise due to collision of an inner peripheral surface of the bellows and an inner ball joint.

### SUMMARY OF THE INVENTION

Accordingly, the present invention has been made to solve the above-mentioned problems occurring in the prior art, and an object of the present invention is to provide a rack-pinion type steering apparatus which allows exterior air to enter the interior of a gearbox to solve a problem of increasing internal pressure of a bellows in a predetermined case, and accordingly, prevents noise from being generated due to the collision of an inner peripheral surface of the bellows and an inner ball joint.

The object of the present invention is not limited thereto, but other unmentioned objects of the present invention also will be clearly understood by those skilled in the art from the following description.

In order to accomplish this object, there is provided a rack-pinion type steering apparatus including: an input shaft coupled to an inside of a housing and having a pinion gear engaged with a rack gear at a lower portion thereof; a bearing coupled to an outer peripheral side of the input shaft and supported by an inner peripheral surface of the housing to be fixed; a plug installed at an upper portion of the bearing and through which the input shaft passes; and a seal member through which the input shaft passes and coupled to an upper portion of the plug, wherein ventilators are formed in one or both of the plug and the seal member.

The seal member may include: a body press-fitted with and coupled to the positioning recess formed at an upper portion of the plug; and an attaching part extending from an inner peripheral surface of the body radially inward and attached to an outer peripheral surface of the input shaft. The ventilator formed in the seal member is axially formed in one or both of the body and the attaching part.

The ventilator formed in the body may be recessed radially inward from an outer peripheral surface of the body, and the ventilator formed in the plug may be recessed radially outward from an inner wall of the positioning recess.

According to the present invention, since air can flow into the interior of a gearbox from the exterior of the gearbox, unlike in the conventional structure in which an internal air flow into the gearbox is blocked at a portion of a rack-pinion type steering apparatus connected with the gearbox through a rack housing and a bellows, a problem of increasing internal pressure of the bellows in a predetermined case can be solved, and accordingly, generation of noise due to the collision between an inner peripheral surface of the bellows and an inner ball joint can be prevented.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram of a rack-pinion type steering apparatus according to the related art;

FIG. 2 is a sectional view showing a main part of a gearbox of FIG. 1;

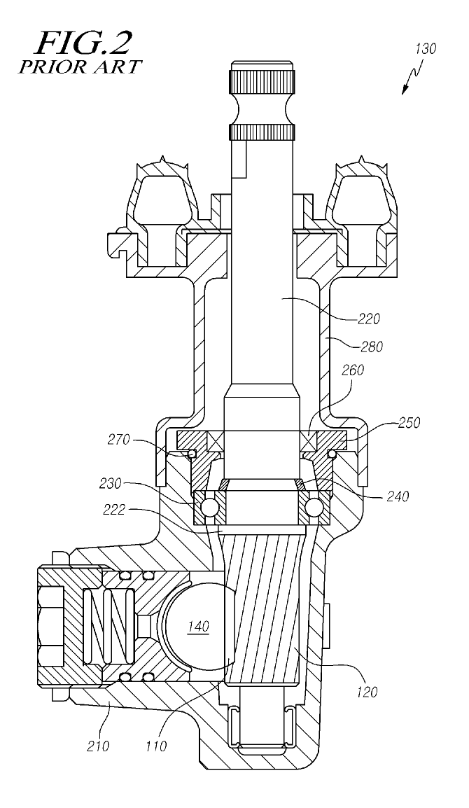

FIG. 3 is a perspective view of a seal member according to an embodiment of the present invention;

FIG. 4 is a sectional view of the seal member of FIG. 3;

FIG. 5 is a perspective view of a seal member according to another embodiment of the present invention;

FIG. 6 is a sectional view of the seal member of FIG. 5;

FIG. 7 is a perspective view of a seal member according to another embodiment of the present invention;

FIG. 8 is a sectional view of the seal member of FIG. 7;

FIG. 9 is a perspective view of a plug according to an embodiment of the present invention and the seal member of FIG. 5; and

FIG. 10 is a view showing an air flow in a gearbox to which the seal member of FIG. 5 is mounted.

### DETAILED DESCRIPTION OF THE PREFERRED EMBODIMENTS

15

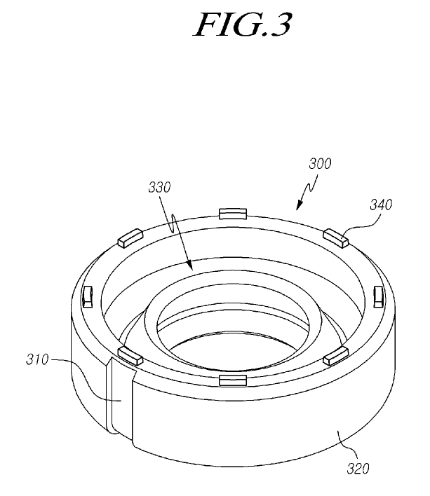

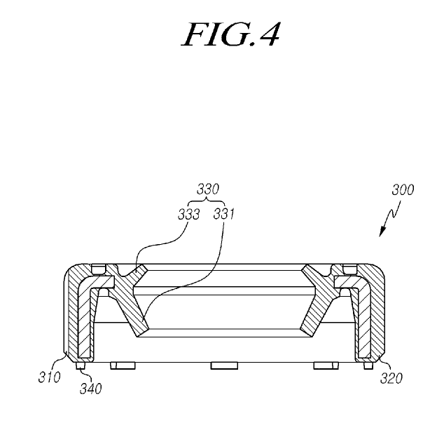

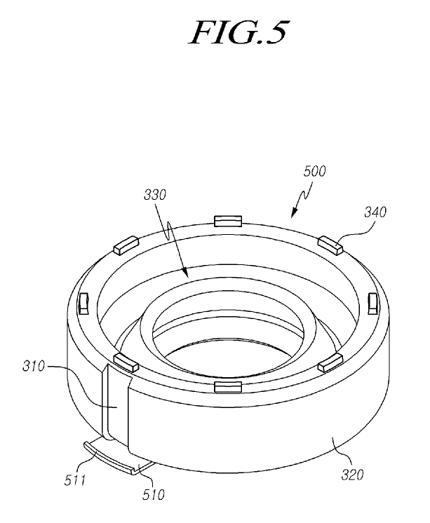

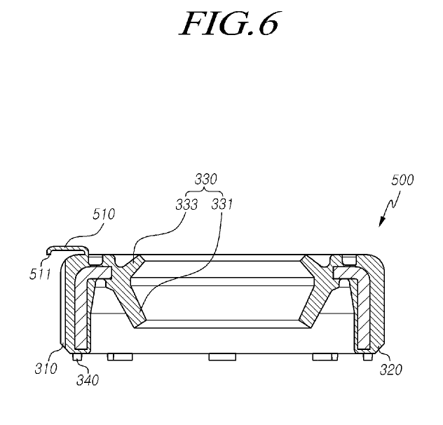

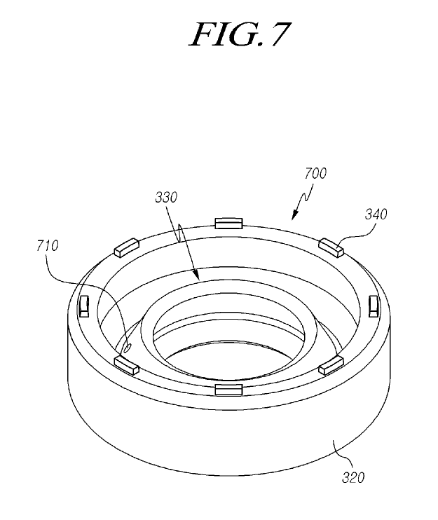

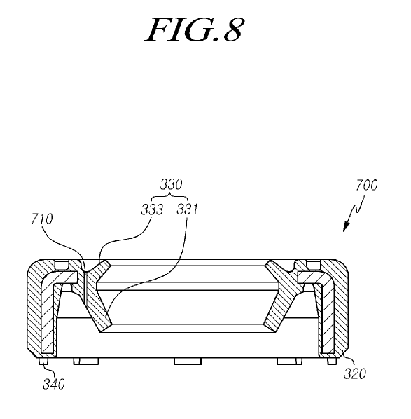

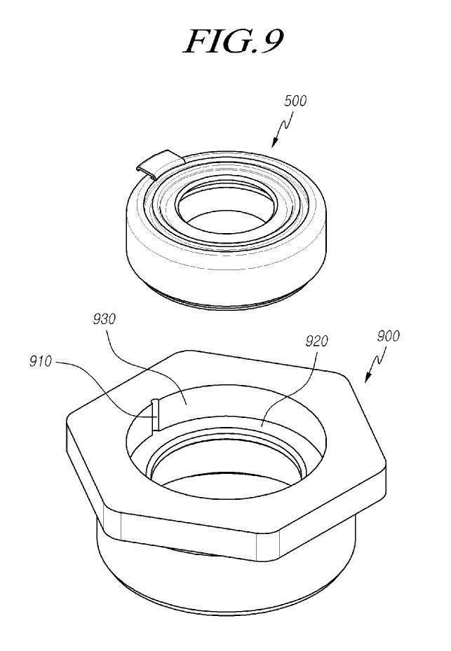

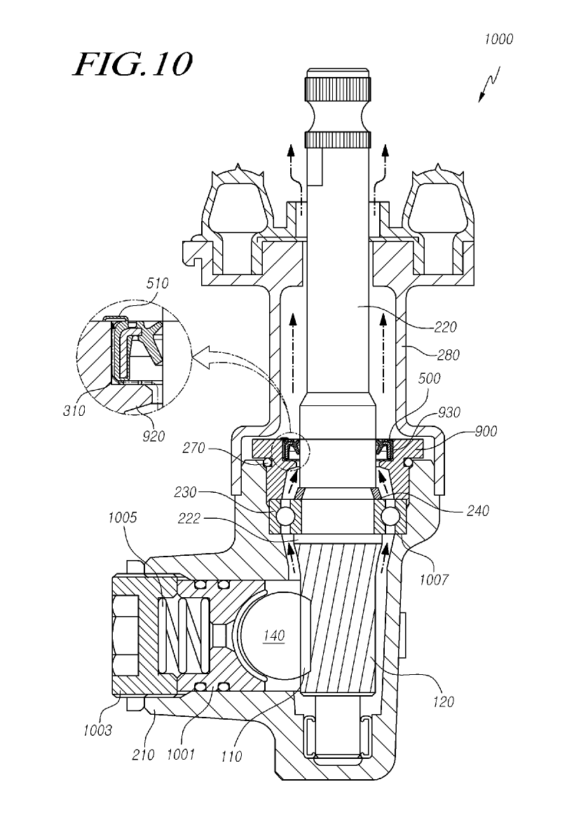

FIG. 3 is a perspective view of a seal member according to an embodiment of the present invention. FIG. 4 is a sectional view of the seal member of FIG. 3. FIG. 5 is a perspective view of a seal member according to another embodiment of the present invention. FIG. 6 is a sectional view of the seal member of FIG. 5. FIG. 7 is a perspective view of a seal member according to another embodiment of the present invention. FIG. 8 is a sectional view of the seal member of FIG. 7. FIG. 9 is a perspective view of a plug according to an embodiment of the present invention and the seal member of FIG. 5. FIG. 10 is a view showing an air flow in a gearbox to which the seal member of FIG. 5 is mounted.

As shown in the drawings, a rack-pinion type steering apparatus according to the embodiment of the present invention includes: an input shaft 220 coupled to an inside of a housing 210 and having a pinion gear 120 engaged with a rack gear 110 at a lower portion thereof; a bearing 230 coupled to an outer peripheral side of the input shaft 220 and supported by an inner peripheral surface of the housing 210 to be fixed; a plug 900 installed at an upper portion of the bearing 230 and through which the input shaft 220 passes; and a seal member 300, 500, and 700 through which the input shaft 220 passes and coupled to an upper portion of the plug 900, and ventilators 310, 710, and 910 are formed in one or both of the plug 900 and the seal member 300, 500, and 700.

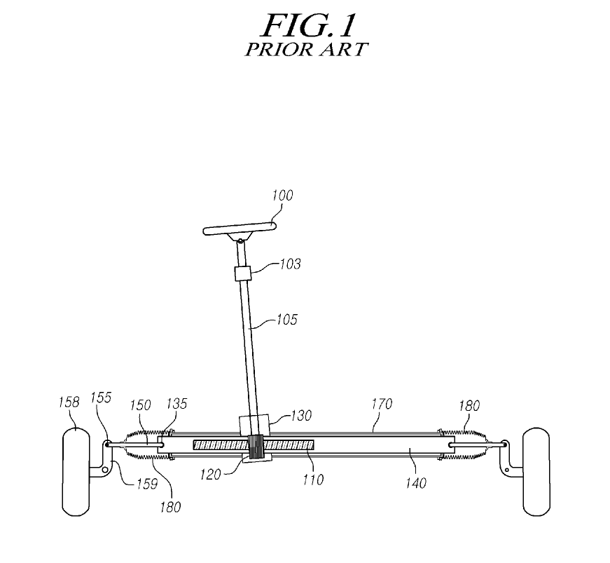

The housing 210 is integrally formed with a rack housing 170 (see FIG. 1), a support yoke 1001 for pushing the rack bar 140 engaged with the pinion gear 120 toward the pinion gear 120 is installed at a lower side of an interior of the housing 210, a yoke plug 1003 is screw-coupled to the housing 210, and a spring 1005 is installed between the yoke plug 1003 and the support yoke 1001, so that the support yoke 1001 resiliently supports a rear surface of the rack bar 140 by using a resilient force of the spring 1005.

The input shaft 220 is coupled to an inside of the housing 210, in which case the pinion gear 120 engaged with the rack gear 110 formed in the rack bar 140 is formed at a lower portion of the input shaft 220 and the input shaft 220 is connected to the steering shaft 105 (see FIG. 1) so that the input shaft 220 is rotated in conjunction with the steering shaft 105 as a driver rotates the steering wheel 100.

The bearing 230 is coupled to an outer peripheral side of the input shaft 220, and an outer peripheral surface of the bearing 230 is inserted into a coupling groove 1007 formed on an inner peripheral surface of the housing 210 to be fixed.

The plug 900 is installed at an upper portion of the bearing 230 and the input shaft 220 passes through the plug 900 to be coupled to the plug 900, and a stepped portion 920 protruding toward a center of the plug 900 is formed at an inner side of the plug 900 and a positioning recess 930 on which the sealing member 300, 500, and 700, which will be described below, is press-fitted and positioned is formed at an upper portion of the stepped portion 920. A space for exhausting air is formed between the stepped portion 920 of the plug 900 and the input shaft 220.

Meanwhile, a ventilator 910 may be formed in an inner wall of the positioning recess 930 of the plug 900, and the ventilator 910 may be recessed from the inner wall of the positioning recess 930 radially outward.

Since the ventilator 910 is formed in the inner wall of the positioning recess 930 of the plug 900, a space for exhausting air can be secured even if the seal member 300, 500, and 700 is press-fitted with and coupled to the positioning recess 930.

The seal member 300, 500, and 700 is coupled to an upper portion of the plug 900, and in more detail, the seal member 300, 500, and 700 is press-fitted with and coupled to the positioning recess 930 formed in the plug 900, the input shaft 220 passes through the seal member 300, 500, and 700 to be coupled to the seal member 300, 500, and 700, and a ventilator 310 and 710 is axially formed in the sealing member 300, 500, and 700.

In a more detailed description of the structure of the seal member 300, 500, and 700, the seal member 300, 500, and 700 includes: a body 320 press-fitted with and coupled to the positioning recess 930 formed at an upper portion of the plug 900; and an attaching part 330 extending from an inner peripheral surface of the body 320 radially inward and attached to an outer peripheral surface of the input shaft 220.

The body 320 has an outer shape corresponding to the shape of the positioning recess 930 to be press-fitted with and coupled to the positioning recess 930. A boss 340 is formed at a lower end of the body 320, and the boss 340 secures a predetermined space between a lower portion of the body 320 and a stepped portion 920 of the plug 900 and may be formed of a resilient material. The boss 340 spaces a lower portion of the body 320 from the stepped portion 920 of the plug 900 by a predetermined interval due to a resilient force when the seal member 300, 500, and 700 is press-fitted with and coupled to the plug 900 so that air can be exhausted through the ventilator 310 formed in the seal member 300 and 500 or the ventilator 910 formed in the plug 900.

The attaching part 330 extends from an inner peripheral surface of the body 320 radially inward, and the attaching part 330 is attached to an outer peripheral surface of the input shaft 220 when the seal member 300, 500, and 700 is coupled to the input shaft 220.

Here, the attaching part 330 may include: a first attaching part 331 an inner diameter of which gradually increases as it goes from a lower end of the first attaching part 331 toward an upper end of the first attaching part 331; and a second attaching part 333 extending from an upper end of the first attaching part 331 such that an inner diameter of the second attaching part 333 gradually decreases toward an upper side.

When the attaching part 330 includes the first attaching part 331 and the second attaching part 333, a lubricant such as grease is contained between an outer peripheral surface of the input shaft 220 and the first and second attaching parts 331 and 333 to reduce friction between the input shaft 220 and the attaching part 330 when the seal member 300, 500, and 700 is coupled to the input shaft 220.

Meanwhile, the ventilators 310 and 710 may be axially formed in one or both of the body 320 and the attaching part 330. FIGS. 3 to 6 show an example in which the ventilator 310 is formed in the body 320, and FIGS. 7 and 8 show an example in which the ventilator 710 is formed in the attaching part 330. Of course, while the ventilators 310 and 710 may be formed only in the body 320 or in the attaching part 330 as shown in the drawings, they may be formed in both the body 320 and the attaching part 330. Further, while it is illustrated in the drawings that one ventilator 310 and 710 formed in the body 320 or the attaching part 330, the number of ventilators 310 and 710 may be two or more.

Here, as shown in FIGS. 3 to 6, when the ventilator 310 is formed in the body 320, the ventilator 310 may be recessed radially inward from an outer peripheral surface of the body 320. The ventilator 310 formed on an outer peripheral surface of the body 320 may have a slit shape.

As shown in FIGS. 7 and 8, when the ventilator 710 is formed in the attaching part 330, the ventilator 710 may have a hole shape axially passing through the attaching part 330.

Referring back to FIGS. 5 and 6, a cover 510 extending radially outward and spaced apart from an upper portion of the ventilator 310 formed in the body 320 by a predetermined interval is provided at an upper portion of the body 320.

The cover 510 interrupts foreign substances from entering the ventilator 310 formed in the body 320. The cover 510 may have a plate shape, and a bending portion 511 bent downward may be formed at an end of the cover 510. The bending portion 511 interrupts foreign substances from being introduced into the ventilator 310 from a side surface of the cover 510.

Meanwhile, the above-described seal member 300, 500, and 700 is formed of a material having a wear-resistant property, low friction, and a low thermal flexibility, and for example, may be formed of an engineered plastic such as polyacetal (POM), polyamide (PA), polycarbonate (PC), polyimide (PI), and polybutyleneterephtalate (PBT), a natural rubber, or a synthetic resin such as polyesterelatomer (PE).

Referring to FIGS. 1 and 10, the air flow in the gearbox will be described.

Interior air of the gearbox 1000 can be exhausted to the outside of the gearbox 1000 at a portion of the steering apparatus connected to the gearbox 1000 with the rack housing 170 and the bellows 180 through the bearing 230, a space between the stepped portion 920 of the plug 900 and the input shaft 220, and the ventilator 310 of the seal member 500, so that an interior and an exterior of the gearbox 1000 can communicate with each other.

According to the present invention, since air can flow into the interior of a gearbox from the exterior of the gearbox, unlike in the conventional structure in which an internal air flow into the gearbox is blocked at a portion of a rack-pinion type steering apparatus connected with the gearbox through a rack housing and a bellows, a problem of increasing internal pressure of the bellows in a predetermined case can be solved, and accordingly, generation of noise due to the collision between an inner peripheral surface of the bellows and an inner ball joint can be prevented.

What is claimed is:

1. A rack-pinion type steering apparatus comprising:
an input shaft coupled to an inside of a housing and having a pinion gear engaged with a rack gear at a lower portion thereof;
a bearing coupled to an outer peripheral side of the input shaft and supported by an inner peripheral surface of the housing to be fixed;
a plug installed at an upper portion of the bearing and through which the input shaft passes; and
a seal member through which the input shaft passes and coupled to an upper portion of the plug,
wherein ventilators are formed in one or both of the plug and the seal member.

2. The rack-pinion type steering apparatus as claimed in claim 1, wherein the seal member comprises:
a body press-fitted with and coupled to the positioning recess formed at an upper portion of the plug; and
an attaching part extending from an inner peripheral surface of the body radially inward and attached to an outer peripheral surface of the input shaft,
wherein the ventilator formed in the seal member is axially formed in one or both of the body and the attaching part.

3. The rack-pinion type steering apparatus as claimed in claim 2, wherein the ventilator formed in the body is recessed radially inward from an outer peripheral surface of the body.

4. The rack-pinion type steering apparatus as claimed in claim 2, wherein the ventilator formed in the plug is recessed radially outward from an inner wall of the positioning recess.

5. The rack-pinion type steering apparatus as claimed in claim 2, wherein a boss is formed at a lower end of the body.

6. The rack-pinion type steering apparatus as claimed in claim 5, wherein the boss is formed of a resilient material.

7. The rack-pinion type steering apparatus as claimed in claim 2, wherein a cover extending radially outward and spaced apart from an upper portion of the ventilator formed in the body by a predetermined interval is provided at an upper portion of the body.

8. The rack-pinion type steering apparatus as claimed in claim 7, wherein a bending portion bent downward is formed at an end of the cover.
